(19) United States
(12) Patent Application Publication
(10) Pub. No.: US 2025/0242940 A1
(43) Pub. Date: Jul. 31, 2025

(54) METHOD FOR DETERMINING AT LEAST ONE CHARACTERISTIC OF A MOVEMENT OF A MOBILE STRUCTURE OF AN AIRCRAFT AND AIRCRAFT COMPRISING A DEVICE FOR ITS IMPLEMENTATION

(71) Applicants: Airbus SAS, BLAGNAC (FR); Airbus Operations Limited, FILTON (GB)

(72) Inventors: Cameron COOKE, BLAGNAC (FR); Chioma NWAEFULU, FILTON (GB)

(21) Appl. No.: 19/037,887

(22) Filed: Jan. 27, 2025

(30) Foreign Application Priority Data
Jan. 29, 2024 (FR) FR2400812

(51) Int. Cl. B64D 45/00; B64C 25/10; G06T 7/00; G06T 7/246; G06T 7/73

(52) U.S. Cl. CPC B64D 45/0005; B64C 25/10; G06T 7/0002; G06T 7/248; G06T 7/74; G06T 2207/30248

(57) ABSTRACT

A method for determining, at a given moment in time, at least one characteristic of a movement of a mobile structure of an aircraft. The method includes determining a pair of coordinates in a reference plane corresponding to a projection of a reference feature forming part of the mobile structure in the reference plane, determining the characteristic of the movement of the mobile structure by comparing the pair of coordinates previously determined with reference coordinate pairs, at least one characteristic of the movement of the mobile structure being associated with each pair of reference coordinates. Also an aircraft having a device for implementing the method.

### CROSS-REFERENCES TO RELATED APPLICATIONS

This application claims the benefit of French Patent Application Number 2400812 filed on Jan. 29, 2024, the entire disclosure of which is incorporated herein by way of reference.

### FIELD OF THE INVENTION

The present application relates to a method for determining at least one characteristic of a movement of a mobile structure of an aircraft, together with an aircraft comprising a device for its implementation.

### BACKGROUND OF THE INVENTION

According to one embodiment, an aircraft comprises several landing gears each one mobile between retracted and deployed positions together with, for each of them, a landing gear housing configured to accommodate the landing gear in the retracted position.

Each landing gear comprises various elements articulated with respect to one another, together with actuators allowing the landing gear to be moved between the retracted and deployed positions.

Each landing gear housing comprises at least one undercarriage door mobile between an open position in which the door allows the landing gear to be in a deployed position and also a closed position in which the door encloses the landing gear housing when the landing gear is in the retracted position.

The aircraft also comprises sensors for determining the position of each door of each landing gear housing and of certain articulated elements and/or actuators of each landing gear.

According to one embodiment, each of these sensors is a proximity sensor allowing a single position of a mobile element, such as one of the articulated elements, of the actuators or of the doors to be determined. Thus, according to one configuration, for a given mobile element, the aircraft comprises two proximity sensors positioned at the two ends of the travel of the given mobile element.

This embodiment is not completely satisfactory because it requires a large number of proximity sensors and a significant cabling, which has an impact on the mass of the aircraft and its maintenance.

According to another drawback, this embodiment does not allow the position of a mobile element to be determined when the latter is not situated at one of the ends of its travel.

### SUMMARY OF THE INVENTION

The present invention aims to overcome all or part of the drawbacks of the prior art.

For this purpose, one subject of the invention is a method for determining, at a given moment in time, at least one characteristic of a movement such as a pivot angle or an angular position of a mobile structure chosen from between an aircraft landing gear and a door of an aircraft landing gear housing, characterized in that the method comprises:
a step for acquiring, at the given moment in time, at least one image on which appears at least one reference feature forming part of the mobile structure,
a step for determining, using the captured image, a pair of coordinates in a reference plane corresponding to a projection of the reference feature in the said reference plane,
a step for comparing the pair of coordinates previously determined with pairs of reference coordinates, there being associated at least one characteristic of the movement of the mobile structure with each pair of reference coordinates, the comparison step consisting in determining the point that has as coordinates those of one of the reference coordinate pairs nearest to the point which has as coordinates those of the pair of coordinates previously determined,
a step for determining the characteristic of the movement of the mobile structure which is associated with the pair of reference coordinates corresponding to the pair of coordinates in the reference plane.

This solution allows, based on a reduced number of elements, a characteristic of a movement of the mobile structure to be determined at each moment of the movement and not only at the start and at the end of the movement.

According to another feature, the step for comparing the pair of coordinates obtained by projection with the reference coordinate pairs consists in determining, in the reference plane, the point which has as coordinates those of one of the reference coordinate pairs nearest to the point which has as coordinates those of the pair of coordinates obtained by projection.

According to another characteristic, the method consists in determining, at the given moment in time, for several reference features, at least one characteristic of the movement for each of them, the characteristic of the movement of the mobile structure corresponding to the average of the characteristics of the movement determined for the various reference features.

According to another characteristic, the method comprises a prior step for determining a reference path in the reference plane for each reference feature.

According to another aspect, the step for determining a reference path consists in determining, for each given angular position of the mobile structure, for each reference feature, a pair of reference coordinates in the reference plane corresponding to a projection of the reference feature in the said reference plane and in associating the pair of reference coordinates and the given angular position.

According to another aspect, the mobile structure is a landing gear of the aircraft.

Another subject of the invention is an aircraft comprising at least one mobile structure chosen from between an aircraft landing gear and a door of an aircraft landing gear housing together with a device allowing a method according to one of the preceding features to be implemented. According to the invention, the device comprises at least one acquisition system configured for capturing at least one image on which at least one reference feature appears forming part of the mobile structure, a database in which reference coordinate pairs are each associated with at least one characteristic of the movement such as a pivot angle or an angular position of the mobile structure, together with at least one processing system configured for:
determining, using an image acquired by the acquisition system, a pair of coordinates in a reference plane corresponding to a projection of the reference feature in the said reference plane,
comparing the pair of coordinates previously determined with the reference coordinate pairs stored in the database, this comparison step consisting in determining the point which has as coordinates those of one of the reference coordinate pairs (X0, Y0) nearest to the point which has as coordinates those of the pair of coordinates (X, Y) previously determined, and
determining the characteristic of the movement of the mobile structure which is associated with the pair of reference coordinates corresponding to the pair of coordinates in the reference plane.

According to another feature, each acquisition system is a camera, more particularly a camera of the Lidar type.

According to another feature, each reference feature forming part of the mobile structure follows a three-dimensional path which extends between first and second end points. As a complement, each acquisition system has a boresight direction, each acquisition system being positioned in such a manner that its boresight direction forms an angle of less than 30° with a plane equidistant from the first and second end points of at least one three-dimensional path.

According to another feature, the device comprises a given number of acquisition system(s), this number being determined such that, for each three-dimensional path, at least one acquisition system has a boresight direction forming an angle of less than 30° with a plane equidistant from the first and second end points of the three-dimensional path.

### BRIEF DESCRIPTION OF THE DRAWINGS

Other features and advantages will become apparent from the description of the invention that follows, which description is given solely by way of example, with reference to the appended drawings in which:

FIG. 1 is a perspective view of an aircraft landing gear, occupying two positions, and of the three-dimensional paths of reference features forming part of the landing gear between its two positions, illustrating one embodiment of the invention,

FIG. 2 shows projections in a reference plane of the three-dimensional paths seen in FIG. 1.

### DETAILED DESCRIPTION OF THE PREFERRED EMBODIMENTS

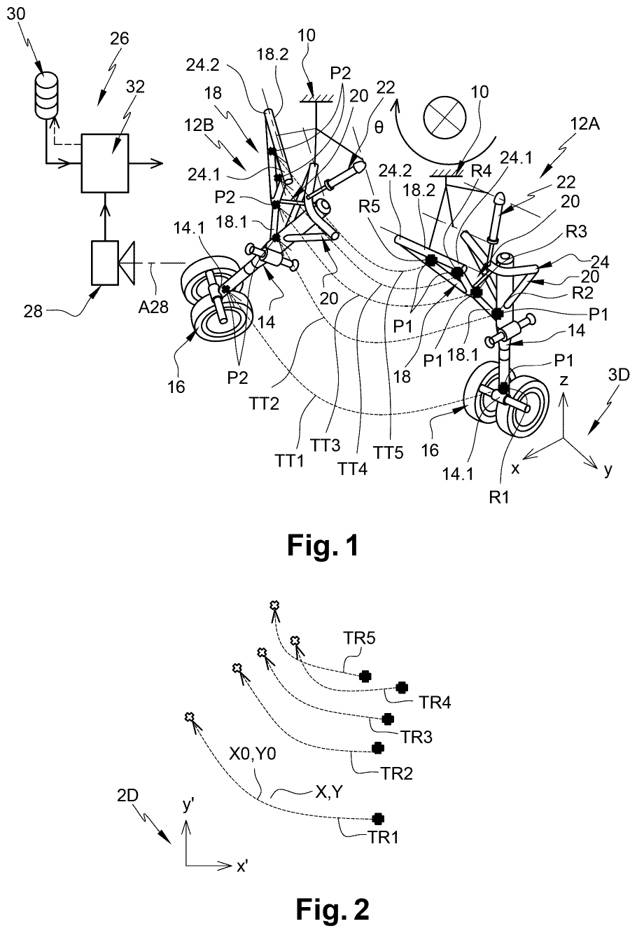

As illustrated in FIG. 1, an aircraft comprises a fixed structure 10 together with at least one landing gear 12A, 12B mobile with respect to the fixed structure 10 between a first position 12A, referred to as deployed, and a second position 12B, referred to as retracted.

According to one embodiment seen in FIG. 1, the landing gear 12A, 12B comprises a leg 14, at least one wheel 16 attached to a first end 14.1 of the leg 14, at least one brace strut 18 connecting the leg 14 and the fixed structure 10 of the aircraft, at least one link rod 20, at least one actuator 22 together with articulations 24 connecting the leg 14, the wheel or wheels 16, the brace strut or brace struts 18, the link rod or link rods 20 and the actuator or actuators 22 together and/or with the fixed structure 10.

The brace strut 18 comprises a first end 18.1 attached to the leg 14 and also a second end 18.2 attached to the fixed structure 10 via first and second articulations 24.1, 24.2.

Irrespective of the embodiment, the landing gear 12A, 12B is a mobile structure, configured for moving with respect to the fixed structure 10, comprising mobile elements from amongst the leg 14, the wheel or wheels 16, the brace strut or brace struts 18, the link rod or link rods 20, the actuator or actuators 22 and the articulation or articulations 24.

As a complement, the aircraft comprises at least one landing gear housing rigidly attached to the fixed structure 10 and configured for accommodating the landing gear 12A, 12B in the retracted position. Each landing gear housing comprises at least one door mobile with respect to the fixed structure 10 between an open position in which the door allows the landing gear 12A, 12B to be in the deployed position and also a closed position in which the door encloses the landing gear housing when the landing gear 12A, 12B is in the retracted position.

Each door of a landing gear housing of the aircraft is a mobile structure, configured to move with respect to the fixed structure 10, comprising at least one mobile element.

Irrespective of the embodiment, the aircraft comprises at least one mobile structure configured to move in a real 3D reference frame according to a given movement with respect to a fixed structure 10 of the aircraft between first and second end positions, the said mobile structure being chosen from between an aircraft landing gear and a door of a landing gear housing.

According to one configuration, the mobile structure pivots about an axis with respect to the fixed structure 10 between first and second end positions which correspond to the deployed and retracted positions, respectively.

Each mobile structure has at least one reference feature R1 to R5 forming part of the mobile structure, which follows a three-dimensional path TT1 in the real 3D reference frame, when the latter moves from one end position to the other. The reference feature may be a point, a straight line, a circle or any other element.

According to the example seen in FIG. 1, the mobile structure has five reference features R1 to R5 which follow three-dimensional paths TT1 to TT5, respectively. For each reference feature R1 to R5 forming part of the mobile structure, each point of its three-dimensional path TT1 to TT5 is associated with one position of the mobile structure. According to one configuration, the reference features R1 to R5 are situated at the first end 14.1 of the leg 14 for the reference feature R1, at the first end 18.1 of the brace strut 18 for the reference feature R2, substantially equidistant from the first and second ends 18.1, 18.2 of the brace strut 18 for the reference feature R3, on the first articulation 24.1 connecting the brace strut 18 and the fixed structure 10 for the reference feature R4 and also substantially equidistant from the first and second articulations 24.1, 24.2 connecting the brace strut 18 and the fixed structure 10 for the reference feature R5. The invention is not of course limited to this configuration for the reference features.

A method for determining, at a given moment in time, at least one characteristic of a movement of the mobile structure comprises:
a step for acquiring, at the given moment in time, at least one image on which at least one reference feature R1 to R5 forming part of the mobile structure appears,
a step for determining, using the acquired image, a pair of coordinates X, Y in a 2D reference plane corresponding to a projection of the reference feature R1 to R5 in the said 2D reference plane,
a step for comparing the pair of coordinates X, Y previously determined with reference coordinate pairs X0, Y0 stored in a database 30, there being associated with each pair of reference coordinates X0, Y0 at least one characteristic of the movement of the mobile structure,
a step for determining the characteristic of the movement of the mobile structure which is associated with the pair of reference coordinates X0, Y0 corresponding to the pair of coordinates X, Y in the 2D reference plane.

In order to implement this method, the aircraft comprises a device 26 for determining at least one characteristic of a movement of the mobile structure which comprises at least one acquisition system 28 configured for capturing at least one image on which at least one reference feature R1 to R5 forming part of the mobile structure appears, a database 30 in which reference coordinate pairs X0, Y0 are each associated with at least one characteristic of the movement of the mobile structure together with at least one processing system 32 configured for:
determining, using an image acquired by the acquisition system 28, a pair of coordinates X, Y in a 2D reference plane corresponding to a projection of the reference feature R1 to R5 in the said 2D reference plane,
comparing the pair of coordinates X, Y previously determined with the reference coordinate pairs X0, Y0 stored in the database 30, and
determining the characteristic of the movement of the mobile structure which is associated with the pair of reference coordinates X0, Y0 corresponding to the pair of coordinates X, Y in the 2D reference plane.

According to one embodiment, the acquisition system 28 is a camera, more particularly a camera of the Lidar type. The invention is not of course limited to this embodiment for the acquisition system 28. Thus, any system allowing any point situated in a three-dimensional reference frame to be projected in a reference plane could be used.

According to one embodiment, the characteristic of the movement determined is the pivot angle or the angular position of the landing gear 12A, 12B. In contrast to the prior art, the two end angular positions of the landing gear corresponding to the retracted and deployed positions are not the only ones determined. The method of the invention allows the angular positions of the intermediate positions of the landing gear between the retracted and deployed positions to be determined.

According to one embodiment, the step for comparing the pair of coordinates X, Y, obtained by projection, with the reference coordinate pairs X0, Y0 stored in the database 30, consists in determining the point which has as coordinates those of one of the reference coordinate pairs X0, Y0 stored in the database 30 nearest to the point which has as coordinates those of the pair of coordinates X, Y obtained by projection.

According to one embodiment, the method for determining, at a given moment in time, at least one characteristic of a movement of the mobile structure consists in implementing the method for several reference features R1 to R5 and in determining, at the given moment in time for each of the reference features R1 to R5, at least one characteristic of the movement for each of them by reproducing the steps a), b), c) and d). According to one embodiment, the characteristic of the movement of the mobile structure sought corresponds to the average of the characteristics of the movement determined for each of the various reference features R1 to R5.

According to one embodiment, the method for determining at least one characteristic of a movement of the mobile structure comprises a prior step for determining a reference path TR1 to TR5 in the 2D reference plane for each reference feature R1 to R5, as illustrated in FIG. 2.

According to one embodiment, for each given angular position of the mobile structure, the latter step consists in capturing at least one image in which the reference features R1 to R5 appear, in determining for each reference feature R1 to R5 a pair of reference coordinates X0, Y0 in the 2D reference plane corresponding to the projection of the reference feature R1 to R5 in the said 2D reference plane and in associating in the database 30 the pair of reference coordinates X0, Y0 and the given angular position.

Thus, to each three-dimensional path TT1 to TT5 in the real 3D reference frame there corresponds a reference path TR1 to TR5 in the 2D reference plane, each reference path TR1 to TR5 corresponding to all of the reference coordinate pairs X0, Y0 determined for the various angular positions occupied by the mobile structure between the first and second end positions.

Each three-dimensional path TT1 to TT5 extends between first and second end points P1, P2. In parallel, each acquisition system 28 has a boresight direction A28. According to one configuration, the acquisition system 28 is positioned in such a manner that its boresight direction A28 forms the smallest possible angle, preferably less than 30°, with a plane equidistant from the first and second end points P1, P2 of at least one three-dimensional path TT1 to TT5. This configuration allows the precision of the estimation of the characteristic of the movement sought to be improved.

The device comprises a given number of acquisition system(s) 28, this number being determined such that, for each three-dimensional path TT1 to TT5, at least one of the acquisition systems 28 has a boresight direction A28 forming the smallest possible angle, preferably less than 30°, with a plane equidistant from the first and second end points P1, P2 of the three-dimensional path TT1 to TT5.

The systems and devices described herein may include a controller or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for determining, at a given moment in time, at least one characteristic of a movement of a mobile structure chosen from an aircraft landing gear and a door of an aircraft landing gear housing, wherein the method comprises:
a step for acquiring, at the given moment in time, at least one image on which at least one reference feature forming part of the mobile structure appears,
a step for determining, based on the at least one image acquired, a pair of coordinates in a reference plane corresponding to a projection of the at least one reference feature in the reference plane,
a step for comparing the pair of coordinates previously determined with reference coordinate pairs, there being associated at least one characteristic of the movement of the mobile structure with each reference coordinate pair, the comparison step comprising determining a point which has as coordinates those of one of the reference coordinate pairs nearest to a point which has as coordinates those of the pair of coordinates previously determined, and,
a step for determining a characteristic of the movement of the mobile structure which is associated with a pair of reference coordinates corresponding to a pair of coordinates in the reference plane.

2. The method according to claim 1, wherein the step for comparing the pair of coordinates with the reference coordinate pairs comprises determining, in the reference plane, a point which has as coordinates those of one of the reference coordinate pairs nearest to a point which has as coordinates those of the pair of coordinates corresponding to the projection of the at least one reference feature in the reference plane.

3. The method according to claim 1, further comprising:
determining, at the given moment in time for several reference features, at least one characteristic of a movement of the mobile structure for each reference feature, the at least one characteristic of the movement of the mobile structure corresponding to an average of the at least one characteristics determined for the several reference features.

4. The method according to claim 1, further comprising:
a step for determining a reference path in the reference plane for each reference feature.

5. The method according to claim 4, wherein the step for determining the reference path comprises, for each given angular position of the mobile structure, in determining for each reference feature a pair of reference coordinates in the reference plane corresponding to a projection of the reference feature in the said reference plane and in associating the pair of reference coordinates and the given angular position.

6. The method according to claim 1, wherein the mobile structure is a landing gear of an aircraft.

7. An aircraft comprising:
at least one mobile structure chosen from an aircraft landing gear and a door of an aircraft landing gear housing;
at least one acquisition system configured for acquiring at least one image on which at least one reference feature forming part of the mobile structure appears;
a database in which reference coordinate pairs are each associated with at least one characteristic of a movement of the at least one mobile structure;
at least one processing system configured for:
determining, using an image acquired by the at least one acquisition system, a pair of coordinates in a reference plane corresponding to a projection of the reference feature in the said reference plane,
comparing the pair of coordinates previously determined with the reference coordinate pairs stored in the database, the comparing comprising determining a point which has as coordinates those of one of the reference coordinate pairs nearest to a point which has as coordinates those of the pair of coordinates previously determined, and
determining a characteristic of the movement of the at least one mobile structure which is associated with the one of the reference coordinates pairs corresponding to the pair of coordinates in the reference plane.

8. The aircraft according to claim 7, wherein the at least one acquisition system comprises a camera.

9. The aircraft according to claim 8, wherein the camera comprises a Lidar camera.

10. The aircraft according claim 7, wherein each reference feature forming part of the at least one mobile structure follows a three-dimensional path which extends between a first end point and a second end point, and
wherein the at least one acquisition system has a boresight direction, the at least one acquisition system positioned such that the boresight direction forms an angle of less than 30° with a plane equidistant from a first end point and a second end point of at least one three-dimensional path.

11. The aircraft according to claim 7, wherein each reference feature forming part of the at least one mobile structure follows a three-dimensional path which extends between a first end point and a second end point,
wherein the aircraft comprises a plurality of acquisition systems, a number of the acquisition systems being determined such that, for each three-dimensional path, at least one acquisition system has a boresight direction forming an angle of less than 30° with a plane equidistant from a first end point and a second end point of the three-dimensional path.
